(19) United States
(12) Patent Application Publication
(10) Pub. No.: US 2012/0131841 A1
(43) Pub. Date: May 31, 2012

(54) Fishing tip-up

(76) Inventor: John GALBRAITH, Port Perry, OH (US)

(21) Appl. No.: 12/926,576

(22) Filed: Nov. 26, 2010

(51) Int. Cl. A01K 97/12; A01K 97/11

(52) U.S. Cl. 43/16; 43/17

(57) ABSTRACT

The fishing tip-up has an upright support and a swinging arm pivotally mounted to the top of the support. A forward segment of the arm pivots downward and toward the support when the rear segment pivots upward The swinging arm is adapted to support a fishing line which extends downward into a fishing hole from the forward segment and to which a bait is attached for attracting a fish. When a fish strikes, the forward segment pivots downward when a force greater than a predetermined value is applied to the fishing line. The predetermined value is adjustable. A magnet is provided in the rear segment of the swinging arm and keeps a reed switch in the support open until a fish strikes. At that time, the rear segment swings up and away from the support with resulting separation of the magnet from the reed switch and concurrent closing of the switch. When the reed switch is closed, a light illuminates.

### FIELD OF THE INVENTION

This invention relates to fishing tip-ups and more particularly to a fishing tip-up which is electrically and magnetically actuated.

### BACKGROUND OF THE INVENTION

Fishermen typically prefer to have a number of locations in which to fish so that if fish are not striking in one location, the fishermen can move to others until they find one where the fish do strike. If the fishermen are in boats, they have a wide choice of locations while if they are fishing from shore they have a more limited choice, but they can still move if fishing from one location proves fruitless. Ice-fishing however is another matter. Extensive preparations are necessary before an ice fisherman can begin to fish. He must usually erect an enclosure to protect himself from the wind, sleet and snow, he must provide heat in the enclosure if the weather is very cold, he must drill a number of holes in the ice and so on. Once the ice fisherman has completed his preparations, he cannot move without a great deal of inconvenience. He must undo the preparations he has already made at his present location and repeat them at a new location. A great deal of time is required for him to do so and in practice once he has set up at one location he does not move.

To increase the odds of catching fish while ice fishing, fishermen will spread their lines out as far possible to cover a wide area. To do so, they will install an un-manned tip-up outside the enclosure and remain in the enclosure and fish from there while keeping their eye on the tip-up. Ice-fishing is best at dawn and dusk at a time when the light is dim or there is total darkness. At such time, a tip-up is very difficult to see even when it is not more than 10 feet from an enclosure. Blowing snow and fog may also contribute to limited visibility. Lanterns may be used to illuminate the tip-up but they draw heavily from a battery since they must remain on continuously. In cold weather, batteries generally perform poorly and the light from a lantern that remains continuously on becomes dim in a relatively short period of time.

Tip-ups that are commercially available have various means for overcoming this problem. One such tip-up has a pin which is released when the device is activated by a strike. When the pin is released, a siren sounds and lights flash. However the pin can become frozen in cold weather and not release at the time of a strike. Other known tip-ups continuously draw from a battery which soon runs down in cold weather. Still others delay the sounding or displaying of a signal when a fish has struck the bait.

In general, the effectiveness of most of the tip-ups that are commercially available falls off in cold weather when they are exposed to adverse weather conditions. Freezing rain, snow and ice can form around the release points of signals such as flags, sirens and lights and prevent the devices from reacting when there is a strike. On occasion, winds can set off the devices as can small fish which may nibble at the bait and cause the tip-ups to react. Until the devices are reset, they do not react later when there is a genuine strike.

### SUMMARY OF THE INVENTION

I have invented a fishing tip-up that signals a strike by means of a bright light, a siren or other way that is unlikely to be missed. The signal, is powered by a battery or other source of energy and only draws from the source when the device is activated. The signal accordingly remains strong over an extended period of time. In addition, no illumination of the tip-up is necessary since a fisherman will see the signal light or hear the siren when the device is activated by a strike. Moreover, my device resets itself automatically if it is activated by the wind, by a nibbling fish or otherwise and has provision for adjusting the sensitivity of the device to the weight or the fighting characteristics of a fish being sought.

Briefly the tip-up of my invention comprises: a signal; an upright support and a swinging arm pivotal relative to the support and having forward and rear segments. The forward segment pivots downward and toward the support when the rear segment pivots upward. The swinging arm is adapted to support a fishing line which extends downward into a fishing hole from the forward segment and to which a bait is attached for attracting a fish. In such case, the forward segment pivots downward when a force greater than a predetermined value is applied to the downwardly extending fishing line. A magnetically activated electrical switch activates the signal which is located in one of either the support or the rear segment of the swinging sun. A magnet is provided in the other of the support and the rear segment for activating the switch. The magnet separates from the switch when the rear segment pivots upward and away from the upright support with resulting activation of the switch and simultaneous activation of the signal.

### DESCRIPTION OF THE DRAWINGS

The fishing tip-up of the invention is described with reference to the accompanying drawings in which:

FIG. 1 is a elevation of the tip-up;

FIG. 2 is an exploded perspective view of the tip-up;

FIG. 3 is an elevation of the tip-up in an armed position;

FIG. 4 is side elevation of the tip-up in which normally closed compartments are open to expose the electrical components of the device; and

FIGS. 5 and 6 illustrate schematically the switch and magnets which activate the signal.

Like reference characters refer to like parts throughout the description of the drawings.

### DESCRIPTION OF PREFERRED EMBODIMENT

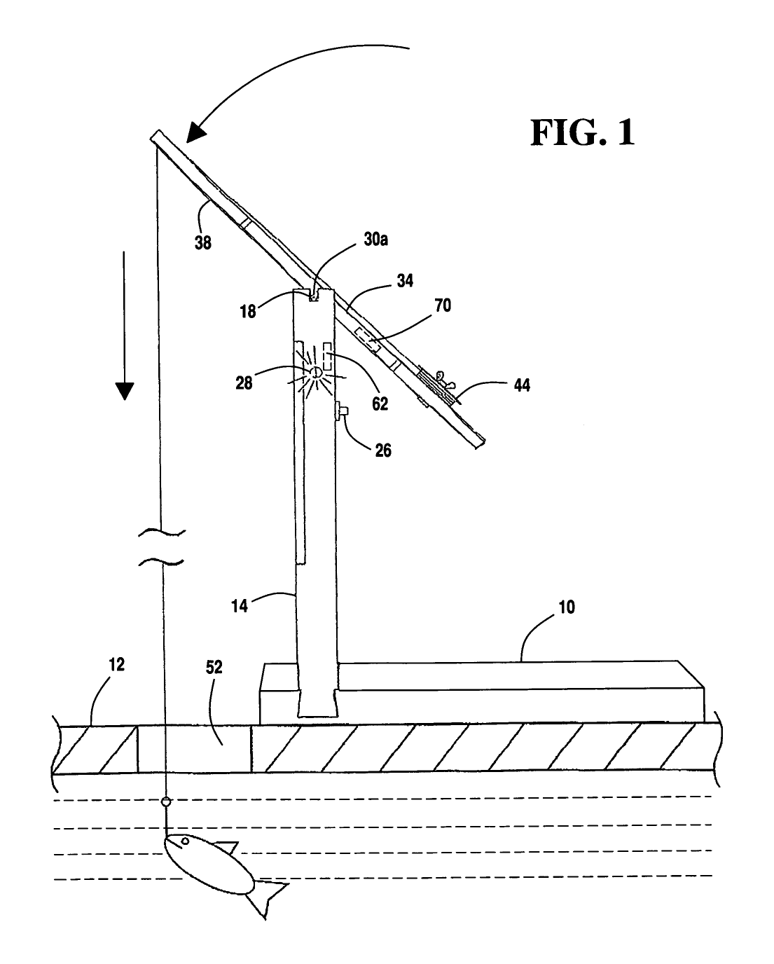

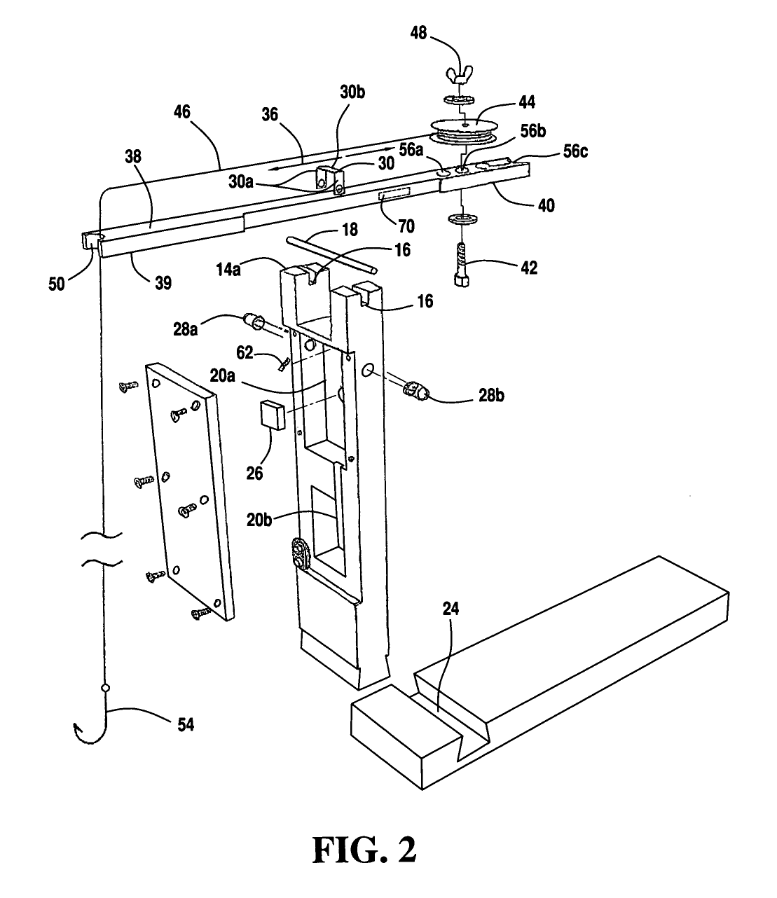

With reference to FIGS. 1 and 2, the fishing tip-up includes a base 10 which, in use, normally rests on a sheet of ice 12 at the surface of a lake or river in below freezing temperatures. An upright support 14 extends upwardly from the support and terminates at an upper wall 14a. The support is removably secured in a slot 24 in the base so that the support can be removed from the base for compact storage when the tip-up is not in use. There is a pair of notches 16 in the upper wall for receipt of a rod 18.

The upright support is hollow and has a rectangular cross-section for receipt of the electrical components required for the tip-up to function. The components are described below and are received in upper and lower compartments 20a,b, respectively, in the support. The compartments are closed by a plate 22 which can be removed to gain access to the interior of the compartments. An on-off switch 26 is attached to one side of the support and a pair of electric lights 28a, b are attached to the side walls of the upright support.

A U-shaped bracket 30 has flanges 30a provided with openings through which rod 18 extends. The web 30b of the bracket is in contact with the upper wall of a swinging arm 38 and the bracket accordingly connects the swinging arm to rod 18. The connection is slightly loose so that the swinging arm can slide longitudinally under the bracket in either of the directions of two headed arrow 36 when sufficient force is applied to the arm.

The rod rests in notches 16 in the upper wall of the upright support and serves as a pivot for the swinging arm to oscillate relative to the support. The swinging arm is composed of two segments, a forward segment 39 and a rear segment 40. The two segments are on opposite sides of rod 18. Openings 56a,b and c are spaced along the rear segment for receipt of a screw 42 which serves as a spindle on which a reel 44 revolves. A wing nut 48 secures the screw to the swinging arm. A number of holes 56a,b and c in the swinging arm allow the position of the reel to be adjusted so that weight on the fishing line which cause the swinging arm to tip can be altered.

A fishing line 46 is wound around the reel. A notch 50 is formed in the forward end of the swinging arm for guiding the line along the arm and downward from the notch. The line extends through an opening 52 in the lee and a hook 54 is attached to its lower end.

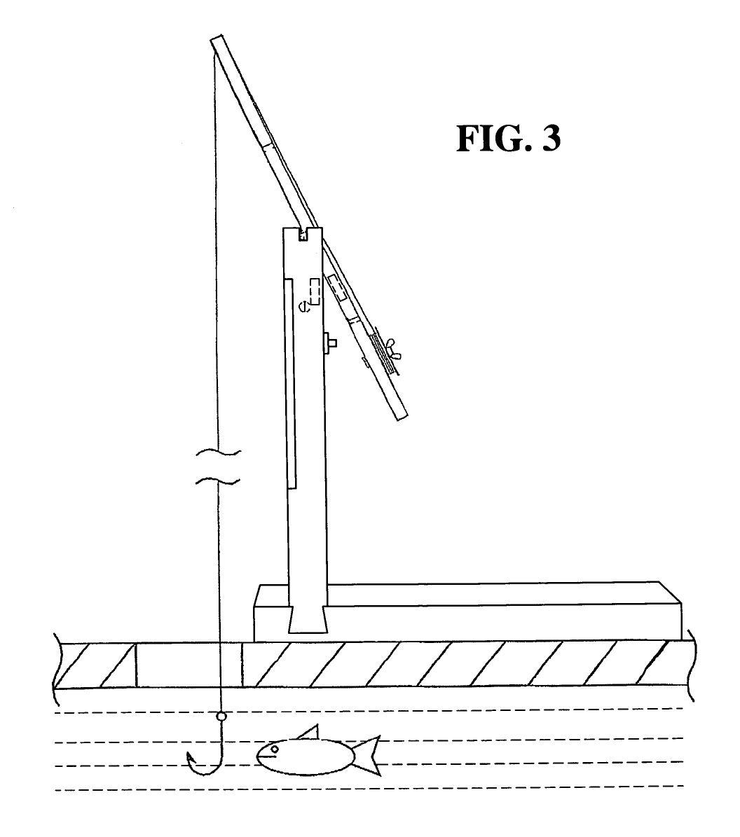

With reference to FIGS. 1 and 3, the swinging arm is held in a generally vertical or “armed” position as illustrated in FIG. 3 by the weight of the reel or other means until a fish strikes the bait on the hook. When a strike occurs, the weight of the fish or the force applied to the line by a struggling fish causes the forward segment of the arm to tip downward to a so-called “tripped” position. In FIG. 1 the forward segment of the swinging arm is at the beginning of its descent toward the tripped position. The weight or force necessary to cause the forward segment to swing downward can be adjusted by sliding the swinging arm forward or backward under bracket 30 or by adjustment of the position of the reel on the swinging arm as is explained above.

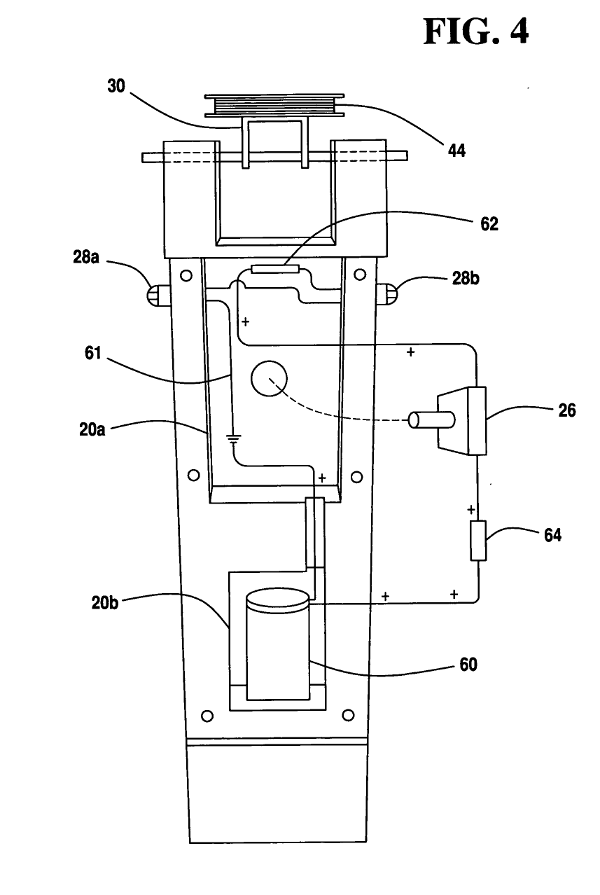

With reference to FIG. 4, mounted in the lower compartment 20b is a battery 60 and in the upper compartment 20a is a closed circuit 61 composed of a normally closed reed switch 62, previously mentioned on-off switch 26, a resistor 64, and lights 28a,b on opposite side walls of the upright support. The circuit is activated by battery 60.

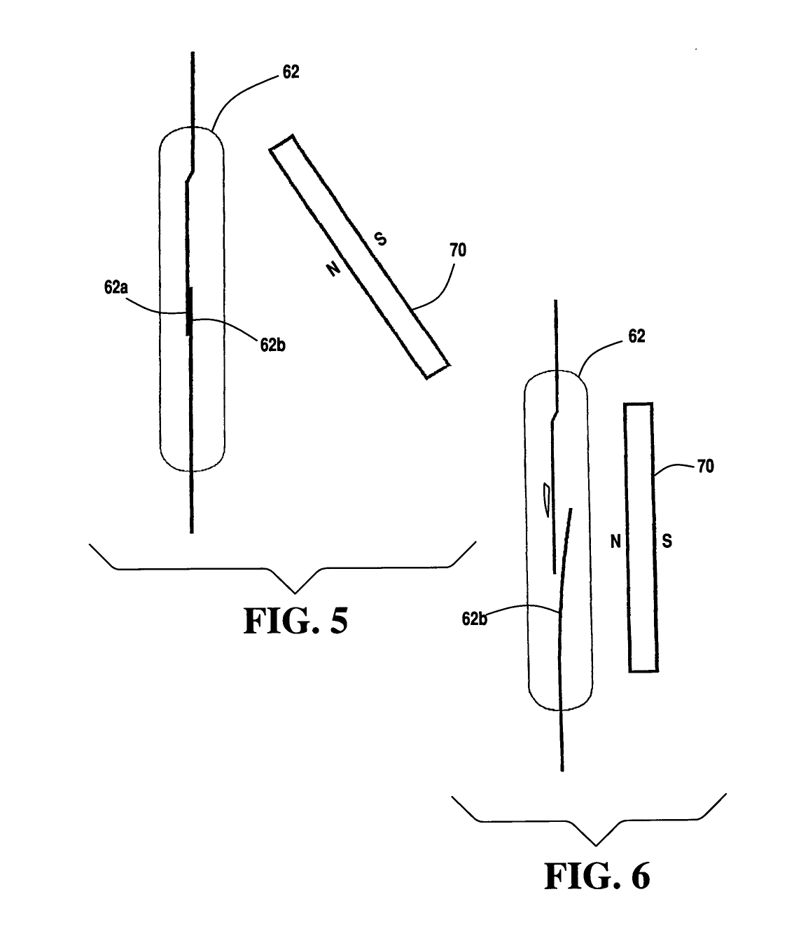

As illustrated in FIG. 5, the contacts 62a,b of the reed switch are resiliently deformable but in the normal closed position are in contact with each other and circuit 61 is closed, assuming that on-off switch 26 is turned on.

With reference to FIGS. 2, 3, 5 and 6, there is mounted within the rear segment of the swinging arm a magnet 70 which is adjacent to reed switch 62 when the swinging arm is in the armed position as illustrated in FIG. 3. The magnetic attraction of contact 62b of the reed switch to the magnet causes the contact to swing toward the magnet as illustrated in FIG. 6 and to separate from the other contact 62a of the switch. Circuit 61 is then open and the lights are off.

As the swinging arm swings to the tripped position illustrated in FIG. 1, the magnet separates from the reed switch as illustrated in FIG. 5 and the magnetic attraction which holds contact 62b apart from contact 62a becomes progressively weaker. When the resilient force of the contact overcomes the magnetic attraction, contact 62b returns to its normal position as illustrated in FIG. 5 and circuit 61 closes. Lights 28a,b then illuminate thereby alerting the ice fisherman who operates the fishing tip-up that the swinging arm has tripped.

The sensitivity of the swinging atm to tipping can be adjusted by altering the position of the reel on the swinging arm and the position of the arm under bracket 30. As the reel is moved forward toward the bracket, the rear segment of the swinging arm will rise with resulting increased separation of magnet 70 from reed switch 62 when the tip-up is in an armed position. As a result, less force on the fishing line will be required to tip the swinging arm. Similarly, the further forward the swinging arm is moved under the bracket, the higher the rear segment will be rise in the armed position with resulting increased sensitivity of the tip-up to a pull on the line.

It will be understood, of course, that modifications can be made in the structure and components of the fishing tip-up of the invention without departing from the scope and purview of the invention as defined in the appended claims. For example, an audible signal such as a buzzer or horn can be substituted for lights 28 or used in conjunction with the lights. In addition, electrical circuit 61 can, be located in the swinging arm and magnet 70 can be located in the upright support.

I claim:

1. A fishing tip-up comprising: a signal; an upright support; a swinging arm pivotal relative to said support and having forward and rear segments, said forward segment pivoting downward and toward said support when said rear segment pivots upward and away from said support; said swinging arm being adapted to support a fishing line which extends downward from said forward segment and to which a bait is attached for attracting a fish, said forward segment pivoting downward when a downward force greater than a predetermined value is applied to said downwardly extending fishing line; a magnetically activated switch for activating said signal, said switch being provided in one of said support and said rear segment; a magnet being provided in the other of said support and said rear segment for activating said switch, said magnet separating from said switch when said rear segment pivots upward and away from said support with resulting activation of said switch and concurrent activation of said signal.

2. The fishing tip-up of claim 1 wherein said downward force which causes said forward segment to pivot downward is adjustable.

3. The fishing tip-up of claim 1 further including a bracket; and a pin pivotal relative to said support and being secured to said bracket, said swinging arm being movably held to said bracket with resulting adjustment in the position of said swinging arm relative to said support such that said downward force which causes said forward segment to pivot downward is adjustable.

4. The fishing tip-up of claim 1 wherein said rear segment has a plurality of openings, any one of which being adapted to receive a spindle around which a reel is adapted to revolve such that said downward force which causes said forward segment to pivot downward is adjustable by selection of the opening in which said spindle is received.

5. The fishing tip-up of claim 1 wherein said switch is provided in said upright support and said magnet is provided in said rear segment of said swinging arm.

6. The fishing tip-up of claim 1 wherein said switch is normally closed, said switch opening as said magnet approaches said switch with resulting deactivation of said signal.

7. The fishing tip-up of claim 1 wherein said signal is an electrical light.

8. The fishing tip-up of claim 1 further including a reel mounted to said swinging arm, said fishing line extending from said reel.

9. A fishing tip-up comprising: a signal; an upright support; a swinging arm pivotal relative to said support and having forward and rear segments, said forward segment pivoting downward and toward said support when said rear segment pivots upward and away from said support; said swinging arm being adapted to support a fishing line which extends downward from said forward segment and to which a bait is attached for attracting a fish, said forward segment pivoting downward when a downward force greater than a predetermined value is applied to said downwardly extending fishing line; a magnetically activated normally closed electrical switch located in said support for activating said signal, a magnet located in said rear segment and separating from said switch when said rear segment pivots upward and away from said support with resulting activation of said switch and concurrent activation of said signal.

10. The fishing tip-up of claim 9 wherein said downward force which causes said forward segment to pivot downward is adjustable.

11. The fishing tip-up of claim 9 further including a bracket; and a pin pivotal relative to said support and being secured to said bracket, said swinging arm being movably held to said bracket with resulting adjustment in the position of said swinging arm relative to said support such that said downward force which causes said forward segment to pivot downward is adjustable.

12. The fishing tip-up of claim 9 wherein said rear segment has a plurality of openings, any one of which being adapted to receive a spindle around which a reel is adapted to revolve such that said downward force which causes said forward segment to pivot downward is adjustable by selection of the opening in which said spindle is received.

13. The fishing tip-up of claim 9 wherein said switch open3 as said magnet approaches said switch with resulting deactivation of said signal.

14. The fishing tip-up of claim 9 wherein said signal is an electrical light.

15. The fishing tip-up of claim 9 further including a reel mounted to said swinging arm, said fishing line extending from said reel.
